(19) United States
(12) Patent Application Publication
(10) Pub. No.: US 2018/0029306 A1
(43) Pub. Date: Feb. 1, 2018

(54) METHODS AND GHOST SUPPORTS FOR ADDITIVE MANUFACTURING

(71) Applicant: GENERAL ELECTRIC COMPANY, Schenectady, NY (US)

(72) Inventors: Scott Alan GOLD, Waynesville, OH (US); Patrick Michael KENNEY, Cincinnati, OH (US)

(21) Appl. No.: 15/220,170

(22) Filed: Jul. 26, 2016

(51) Int. Cl. B29C 67/00

(52) U.S. Cl. CPC B29C 67/0074; B33Y 10/00

(57) ABSTRACT

The present disclosure generally relates to methods for additive manufacturing (AM) that utilize ghost support structure in the process of building objects, as well as novel ghost support structures to be used within these AM processes. The ghost support structures include a portion of powder that is scanned with an energy beam having insufficient power to fuse the powder. The ghost supports control timing of the additive manufacturing process and allow portions of the object to cool to a desired temperature before adjacent portions of the object are scanned.

### INTRODUCTION

The present disclosure generally relates to methods for additive manufacturing (AM) that utilize support structures in the process of building objects, as well as novel support structures to be used within these AM processes.

### BACKGROUND

AM processes generally involve the buildup of one or more materials to make a net or near net shape (NNS) object, in contrast to subtractive manufacturing methods. Though “additive manufacturing” is an industry standard term (ASTM F2792), AM encompasses various manufacturing and prototyping techniques known under a variety of names, including freeform fabrication, 3D printing, rapid prototyping/tooling, etc. AM techniques are capable of fabricating complex components from a wide variety of materials. Generally, a freestanding object can be fabricated from a computer aided design (CAD) model. A particular type of AM process uses an energy beam, for example, an electron beam or electromagnetic radiation such as a laser beam, to sinter or melt a powder material, creating a solid three-dimensional object in which particles of the powder material are bonded together. Different material systems, for example, engineering plastics, thermoplastic elastomers, metals, and ceramics are in use. Laser sintering or melting is a notable AM process for rapid fabrication of functional prototypes and tools. Applications include direct manufacturing of complex workpieces, patterns for investment casting, metal molds for injection molding and die casting, and molds and cores for sand casting. Fabrication of prototype objects to enhance communication and testing of concepts during the design cycle are other common usages of AM processes.

Selective laser sintering, direct laser sintering, selective laser melting, and direct laser melting are common industry terms used to refer to producing three-dimensional (3D) objects by using a laser beam to sinter or melt a fine powder. For example, U.S. Pat. No. 4,863,538 and U.S. Pat. No. 5,460,758 describe conventional laser sintering techniques. More accurately, sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the powder material. Although the laser sintering and melting processes can be applied to a broad range of powder materials, the scientific and technical aspects of the production route, for example, sintering or melting rate and the effects of processing parameters on the microstructural evolution during the layer manufacturing process have not been well understood. This method of fabrication is accompanied by multiple modes of heat, mass and momentum transfer, and chemical reactions that make the process very complex.

FIG. 1 is schematic diagram showing a cross-sectional view of an exemplary conventional system 100 for direct metal laser sintering (DMLS) or direct metal laser melting (DMLM). The apparatus 100 builds objects, for example, the part 122, in a layer-by-layer manner by sintering or melting a powder material (not shown) using an energy beam 136 generated by a source such as a laser 120. The powder to be melted by the energy beam is supplied by reservoir 126 and spread evenly over a build plate 114 using a recoater arm 116 travelling in direction 134 to maintain the powder at a level 118 and remove excess powder material extending above the powder level 118 to waste container 128. The energy beam 136 sinters or melts a cross sectional layer of the object being built under control of the galvo scanner 132. The build plate 114 is lowered and another layer of powder is spread over the build plate and object being built, followed by successive melting/sintering of the powder by the laser 120. The process is repeated until the part 122 is completely built up from the melted/sintered powder material. The laser 120 may be controlled by a computer system including a processor and a memory. The computer system may determine a scan pattern for each layer and control laser 120 to irradiate the powder material according to the scan pattern. After fabrication of the part 122 is complete, various post-processing procedures may be applied to the part 122. Post processing procedures include removal of excess powder by, for example, blowing or vacuuming. Other post processing procedures include a stress relief process. Additionally, thermal, mechanical, and chemical post processing procedures can be used to finish the part 122.

The apparatus 100 is controlled by a computer executing a control program. For example, the apparatus 100 includes a processor (e.g., a microprocessor) executing firmware, an operating system, or other software that provides an interface between the apparatus 100 and an operator. The computer receives, as input, a three dimensional model of the object to be formed. For example, the three dimensional model is generated using a computer aided design (CAD) program. The computer analyzes the model and proposes a tool path for each object within the model. The operator may define or adjust various parameters of the scan pattern such as power, speed, and spacing, but generally does not program the tool path directly.

It is possible that during laser sintering/melting portions of a three-dimensional object that are in close proximity may become deformed or fused together. For example, powder located between two portions of the object may unintentionally sinter due to heat radiating from the portions of the object.

In view of the above, it can be appreciated that there are problems, shortcomings or disadvantages associated with AM techniques, and that it would be desirable if improved methods of supporting objects and support structures were available.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its purpose is to present some concepts of one or more aspects in a simplified form as a prelude to the more detailed description that is presented later.

In one aspect, the disclosure provides a method of fabricating an object. The method includes (a) irradiating a first portion of a layer of powder in a powder bed with an energy beam in a first series of scan lines to form a fused region; (b) scanning a second portion of the layer of powder in a second series of scan lines using a reduced energy beam power that is insufficient to fuse the powder; (c) providing a subsequent layer of powder over the powder bed by passing a recoater arm over the powder bed from a first side of the powder bed to a second side of the powder bed; and (d) repeating steps (a), (b), and (c) until the fused region forms the object in the powder bed. The second series of scan lines is selected based on a thermal dissipation rate of the first portion.

In another aspect, the disclosure provides a method of fabricating an object based on a three dimensional computer model including the object and a solid support adjacent to the object using a manufacturing apparatus including a powder bed, energy beam, and a recoater arm. The method includes scanning a first set of scan lines corresponding to the object with the energy beam using a first power that is sufficient to melt a layer of powder in the powder bed. The method also includes scanning a second set of scan lines corresponding to the solid support in the powder bed with the energy beam using a second power that is insufficient to fuse the layer of powder in the powder bed.

These and other aspects of the invention will become more fully understood upon a review of the detailed description, which follows.

### BRIEF DESCRIPTION OF THE DRAWINGS

FIG. 1 is schematic diagram showing an example of a conventional apparatus for additive manufacturing.

FIG. 2 illustrates a plan view of a powder bed during fabrication of an example object in accordance with aspects of the present disclosure.

FIG. 3 illustrates another plan view of a powder bed showing an example scan pattern in accordance with aspects of the present disclosure.

FIG. 4 illustrates a front view of another example object and ghost support according to an aspect of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

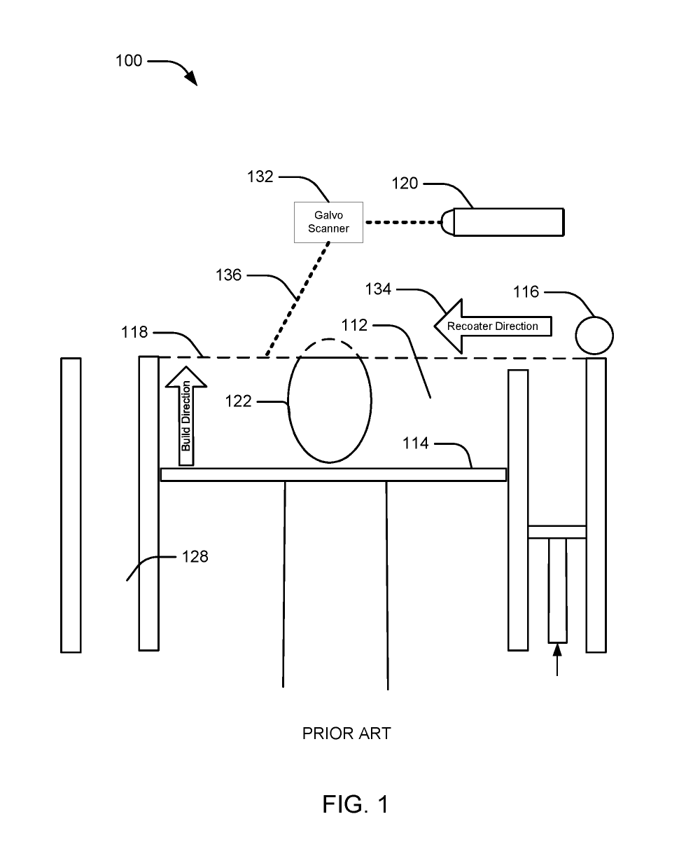

During various additive manufacturing processes such as DMLM and DMLS, heat from a previously scanned portion of an object may impact the scanning of a nearby portion of the object. For example, the heat may lead to unintentional melting or sintering of powder, which may result in unintentionally fused portions of the object or an otherwise deformed object. The disclosure provides for ghost supports for regulating the temperature and related properties of the object during fabrication. For example, a ghost support may be added to a model to provide a timing delay between successive layers during which heat may dissipate from a previously scanned portion of the object. A ghost support may include any portion of powder that is scanned without becoming a portion of the object. For example, the ghost support may be scanned with the power of the laser 120 set to a level that is insufficient to fuse the powder. As another example, a ghost support may be fabricated as a solid support separated from the object. The methods disclosed herein for fabricating an object using ghost supports may be performed by the apparatus 100 (FIG. 1), a person operating the apparatus 100, or a computer processor controlling the apparatus 100.

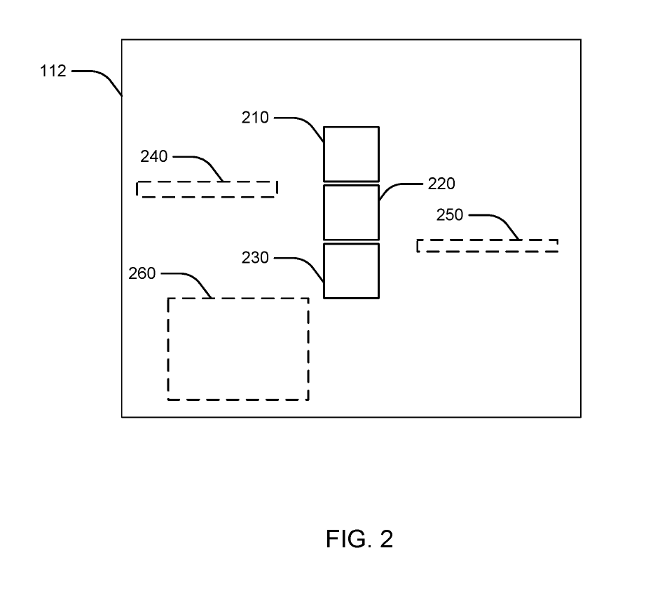

FIG. 2 illustrates a plan view of the powder bed 112 during fabrication of an example object 200 including portions 210, 220, and 230. As illustrated the portions 210, 220, and 230 may be in close proximity to each other. In an aspect, if the laser 120 melts the powder corresponding to each of portions 210, 220, and 230 in quick succession, the portions 210, 220, and 230 may fuse together. For example, when forming portions 210, 220, and 230, the laser 120 may be set to a power sufficient to melt the powder along a scan line having a melting width. When the laser melts powder corresponding to the portion 220, the molten material in the portion 210 may not have cooled and the thin line of powder between the portion 210 and the portion 220 may melt. Alternatively, the molten material may push the unfused powder away. The molten material may then fuse with the molten material in the portion 220. In another aspect, the heat radiating from the portion 210 and the portion 220 may cause the thin line of powder between the portion 210 and the portion 220 to sinter together without melting. In either case, the portion 210 may be fused to the portion 220 when the portions were intended to be separate.

In an aspect, the apparatus 100 may build ghost supports 240, 250 and 260 to regulate the build time and thermal dissipation during fabrication of the object 200. For example, the ghost supports 240, 250, and 260 may be built by scanning a second portion of the layer of the powder according to the scan pattern with the laser off. For example, the laser 120 scans the second portion of the layer of powder according to the scan pattern with the laser 120 off or at a reduced powder. Accordingly, when the galvo scanner 132 scans the ghost supports 240, 250, and 260, the layer of powder may not melt or sinter. The energy beam 136 may still move over the scan pattern, taking time, and allowing one or more of the portions 210, 220, or 230 to cool. In an aspect, the size of the second portion of the layer of powder is based on the thermal dissipation rate of the first portion of the object. For example, the size is set to allow the first portion of the object to solidify or reach a desired temperature before scanning the second portion of the layer of powder is complete. Therefore, for example, the portion 210 may cool sufficiently before melting the portion 220 begins so that the portion 210 and the portion 220 do not fuse together.

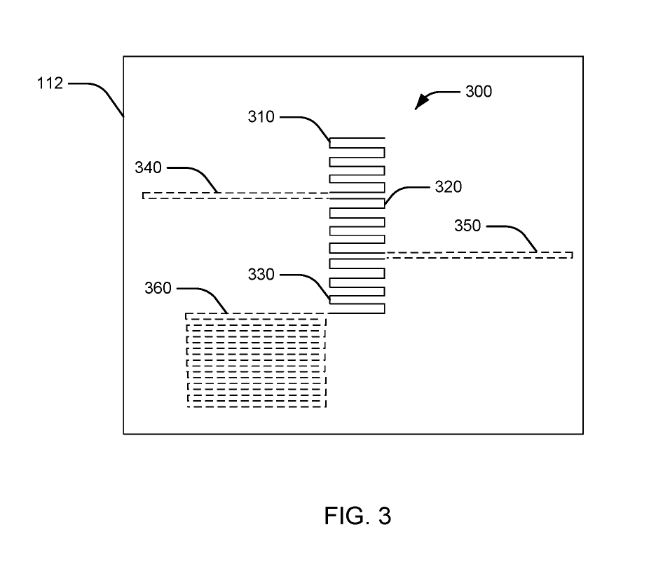

FIG. 3 illustrates another plan view of the powder bed 112 showing an example scan pattern 300 for building the portions 210, 220, and 230. In an aspect, a first portion 310 of the scan pattern may be scanned with the laser 120 on. The power of the laser 120 may be set to an appropriate power for melting the powder. The galvo scanner 132 may scan one or more scan lines across the portion 310 and melt the powder to form the portion 210. Upon reaching the end of portion 310, corresponding to the portion 210, the laser 120 may be turned off. The portion 340 may be scanned with the laser 120 off. Accordingly, the laser 120 may scan the portion 340 but not melt the powder. Upon reaching the end of the portion 340, the laser 120 may be turned back on for scanning the portion 320. The galvo scanner 132 may scan one or more scan lines across the portion 320 and melt the powder to form the portion 220. Upon reaching the end of portion 320, the laser 120 may be turned off. The portion 350 may be scanned with the laser 120 off. Accordingly, the galvo scanner 132 may scan the portion 350 but not melt the powder. Upon reaching the end of the portion 350, the laser 120 may be turned back on for scanning the portion 330. The galvo scanner 132 may scan one or more scan lines across the portion 330 and melt the powder to form the portion 230.

In an aspect, the laser 120 may be turned off for scanning the portion 360. For example, the portion 360 may be scanned after completing all of the portions of the object 200 in the layer. The portion 360 may be used to allow all of the portions in the layer to cool before moving to the subsequent layer. Allowing the portions 210, 220, 230 to cool before applying the subsequent layer of powder may prevent the subsequent layer of powder from disturbing the portions 210, 220, 230 (e.g. causing them to deform). In an aspect, allowing the portions 210, 220, 230 to cool may allow for a portion of the object 200 in the subsequent layer to form properly. For example, a portion of the object 200 in the subsequent layer that overlaps one of the portions 210, 220, 230 may fuse to the underlying solidified portion when the powder is melted. The solidified portion may provide support for the newly melted layer and prevent movement or flow of the newly melted layer.

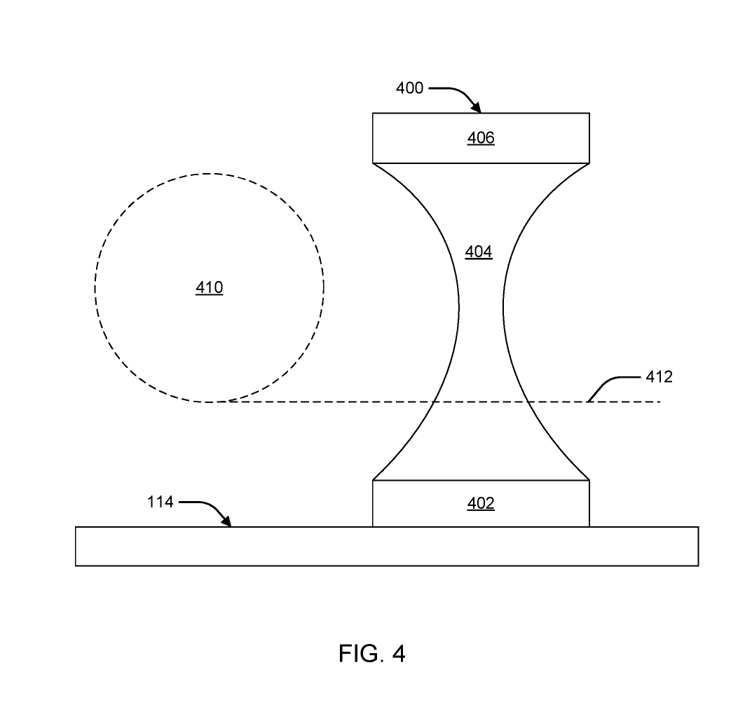

FIG. 4 illustrates a front view showing multiple layers of another example object 400 and ghost support 410 according to an aspect of the present disclosure. The object 400 has a generally hour-glass shape including a base portion 402, a narrow middle portion 404, and a wider top portion 406. The object 400 is build layer-by-layer where each layer can be represented by a horizontal cross-section of the object 400. The base portion 402 is built directly on the build plate 114. The base portion 402 has a horizontal cross-section with sufficient area to allow for cooling. For example, the time galvo scanner 132 takes to scan the horizontal cross-section of the base portion 402 is sufficient for heat to dissipate from a preceding layer before the next layer is scanned. Accordingly, it is unnecessary to scan the ghost support 410 in the layers of the base portion 402. The narrow middle portion 404, however, has a smaller horizontal-cross sectional area. Accordingly, the ghost support 410 provides for a timing delay for the object 400 to cool and solidify between successive layers during fabrication of the narrow middle portion 404. The wider top portion 406, once again, has a horizontal cross-section with sufficient area to allow for sufficient cooling. The ghost support 410 represents a portion of powder that is scanned by the galvo scanner 132. In an aspect, the laser 120 is turned off while scanning the ghost support 410 such that the powder corresponding to ghost support 410 is not fused. In other aspects, the laser 120 may be set to a reduced power or a normal power, although doing so may consume additional energy and powder. The ghost support 410 may be located a minimum distance from the object 400 (e.g., at least 1 centimeter) such that the ghost support 410 is thermally and/or physically isolated from the object 400. The ghost support 410 is illustrated as having a circular vertical cross-section. For example, the ghost support 410 may be a sphere or cylinder. The horizontal width represents the horizontal cross-sectional area of the ghost support 410. It should be appreciated that the actual shape of the ghost support 410 may be any shape because, in at least some embodiments, the ghost support 410 is not a solid object.

As the horizontal cross-sectional area of the object 400 decreases toward the narrow middle portion 404, each subsequent layer takes less time to scan. At a layer 412, for example, the horizontal cross-section area of the object 400 reaches a point where the object 400 does not cool sufficiently between layers. The layer 412 corresponds to a bottom layer of the ghost support 410. That is, when the horizontal cross-sectional area of the object 400 in a layer is less than a threshold, a layer of the ghost support 410 is scanned. The threshold may be determined based on a thermal dissipation rate of the first portion of the object. The thermal dissipation rate indicates a rate at which the first portion of the object cools. The thermal dissipation rate may be modeled based on, for example, the size of the first portion of the object and the structures or powder surrounding the first portion of the object. For example, a portion of the object surrounded by powder cools more slowly than a portion of the object connected to a lower portion of the object. The thermal dissipation rate is used to determine a threshold time until the first portion of the object solidifies or reaches a desired temperature. The threshold time can be converted into a threshold area based on the laser scan parameters such as scan speed.

In an aspect, the horizontal cross-sectional area of the ghost support 410 in any layer is inversely proportional to the horizontal cross-sectional area of the object 400. The total horizontal cross-sectional area of the ghost support 410 and the object 400 may remain substantially constant such that the total scan time for each layer is substantially constant, giving each layer time to cool. For example, the total horizontal cross-sectional area may vary by less than 10 percent while the horizontal-cross sectional area of the object 400 is less than the threshold.

The thermal properties of the object 400 may be determined according to a thermal model. An example thermal model is described in, D. Rosenthal, “The theory of moving sources of heat and its application to metal treatments,” Transactions of the American Society of Mechanical Engineers, vol. 68, pp. 849-866, 1946. Variations of the Rosenthal model are described in N. Christenson et al., “The distribution of temperature in arc welding,” British Welding Journal, vol. 12, no. 2, pp. 54-75, 1965 and A. C. Nunes, “An extended Rosenthal Weld Model,” Welding Journal, vol. 62, no. 6, pp. 165s-170s, 1983. Other thermal models are described in E. F. Rybicki et al., “A Finite-Element Model for Residual Stresses and Deflections in Girth-Butt Welded Pipes,” Journal of Pressure Vessel Technology, vol. 100, no. 3, pp. 256-262, 1978 and J. Xiong et al., “Bead geometry prediction for robotic GMAW-based rapid manufacturing through a neural network and a second-order regression analysis,” Journal of Intelligent Manufacturing, vol. 25, pp. 157-163, 2014. A thermal model may be used to determine the need for the ghost support 410 and the dimensions thereof based on a three-dimensional computer model (e.g., a computer aided design (CAD) model) of the object 400.

In an aspect, the analysis or modeling of an object 400 for any given layer is based on the immediately preceding layers and not any subsequent layers. The subsequent layers have not yet been fabricated and do not affect the thermal dissipation of the given layer. For example, the threshold for the horizontal cross-sectional area of the object 400 may be based on the layer 412 as well as a number of preceding layers. Accordingly, as illustrated in FIG. 4, two layers having the same horizontal cross-sectional area of the object 400 may have different sized layers of the ghost support 410. For example, the widest portion of the ghost support 410 is located slightly above the narrowest portion of the object 400.

In an aspect, the apparatus 100 further includes a thermal sensor such as a pyrometer or a thermal imaging camera. The thermal sensor provides information (e.g., a temperature) regarding the powder bed 112 or a portion of the object 400. The thermal sensor is used to determine thermal properties of the object 400 such as the thermal dissipation rate. The thermal properties of the object 400 are then used to dynamically adjust the dimensions of the ghost support 410 during the build. In another aspect, the dimensions of the ghost support 410 are adjusted for subsequent builds.

In an aspect, the apparatus 100 forms the object 400 based on a three dimensional computer model of the object. Using a CAD program, the operator modifies the three dimensional model of the object to include the ghost support 410. The operator may use software to generate one or more ghost supports within the three dimensional model as solid objects. When the three dimensional model is provided to the apparatus 100, the operator sets the scan parameters for the ghost support 410 such that the scanning does not result in fusing of the powder. Accordingly, while the ghost support 410 appears to be a solid object within the three dimensional model, the ghost support 410 is not actually fabricated. Therefore, resources such as energy and unfused powder may be conserved.

In an aspect, multiple supports may be used in combination to support fabrication of an object, prevent movement of the object, and/or control thermal properties of the object. That is, fabricating an object using additive manufacturing may include use of one or more of: scaffolding, tie-down supports, break-away supports, lateral supports, conformal supports, connecting supports, surrounding supports, keyway supports, breakable supports, leading edge supports, or powder removal ports. The following patent applications include disclosure of these supports and methods of their use:

U.S. patent application No. 15/042,019, titled “ METHOD AND CONFORMAL SUPPORTS FOR ADDITIVE MANUFACTURING” with attorney docket number 037216.00008, and filed Feb. 11, 2016;

U.S. patent application Ser. No. 15/042,024, titled “ METHOD AND CONNECTING SUPPORTS FOR ADDITIVE MANUFACTURING” with attorney docket number 037216.00009, and filed Feb. 11, 2016;

U.S. patent application Ser. No. 15/041,973, titled “METHODS AND SURROUNDING SUPPORTS FOR ADDITIVE MANUFACTURING” with attorney docket number 037216.00010, and filed Feb. 11, 2016;

U.S. patent application Ser. No. 15/042,010, titled “METHODS AND KEYWAY SUPPORTS FOR ADDITIVE MANUFACTURING” with attorney docket number 037216.00011, and filed Feb. 11, 2016;

U.S. patent application Ser. No. 15/042,001, titled “METHODS AND BREAKABLE SUPPORTS FOR ADDITIVE MANUFACTURING” with attorney docket number 037216.00012, and filed Feb. 11, 2016;

U.S. patent application Ser. No. 15/041,991, titled “METHODS AND LEADING EDGE SUPPORTS FOR ADDITIVE MANUFACTURING” with attorney docket number 037216.00014, and filed Feb. 11, 2016; and

U.S. patent application Ser. No. 15/041,980, titled “METHOD AND SUPPORTS WITH POWDER REMOVAL PORTS FOR ADDITIVE MANUFACTURING” with attorney docket number 037216.00015, and filed Feb. 11, 2016.

The disclosure of each of these applications are incorporated herein in their entirety to the extent they disclose additional support structures that can be used in conjunction with the support structures disclosed herein to make other objects.

Additionally, scaffolding includes supports that are built underneath an object to provide vertical support to the object. Scaffolding may be formed of interconnected supports, for example, in a honeycomb pattern. In an aspect, scaffolding may be solid or include solid portions. The scaffolding contacts the object at various locations providing load bearing support for the object to be constructed above the scaffolding. The contact between the support structure and the object also prevents lateral movement of the object.

Tie-down supports prevent a relatively thin flat object, or at least a first portion (e.g. first layer) of the object from moving during the build process. Relatively thin objects are prone to warping or peeling. For example, heat dissipation may cause a thin object to warp as it cools. As another example, the recoater may cause lateral forces to be applied to the object, which in some cases lifts an edge of the object. In an aspect, the tie-down supports are built beneath the object to tie the object down to an anchor surface. For example, tie-down supports may extend vertically from an anchor surface such as the platform to the object. The tie-down supports are built by melting the powder at a specific location in each layer beneath the object. The tie-down supports connect to both the platform and the object (e.g., at an edge of the object), preventing the object from warping or peeling. The tie-down supports may be removed from the object in a post-processing procedure.

A break-away support structure reduces the contact area between a support structure and the object. For example, a break-away support structure may include separate portions, each separated by a space. The spaces may reduce the total size of the break-away support structure and the amount of powder consumed in fabricating the break-away support structure. Further, one or more of the portions may have a reduced contact surface with the object. For example, a portion of the support structure may have a pointed contact surface that is easier to remove from the object during post-processing. For example, the portion with the pointed contact surface will break away from the object at the pointed contact surface. The pointed contact surface stills provides the functions of providing load bearing support and tying the object down to prevent warping or peeling.

Lateral support structures are used to support a vertical object. The object may have a relatively high height to width aspect ratio (e.g., greater than 1). That is, the height of the object is many times larger than its width. The lateral support structure is located to a side of the object. For example, the object and the lateral support structure are built in the same layers with the scan pattern in each layer including a portion of the object and a portion of the lateral support structure. The lateral support structure is separated from the object (e.g., by a portion of unmelted powder in each layer) or connected by a break-away support structure. Accordingly, the lateral support structure may be easily removed from the object during post-processing. In an aspect, the lateral support structure provides support against forces applied by the recoater when applying additional powder. Generally, the forces applied by the recoater are in the direction of movement of the recoater as it levels an additional layer of powder. Accordingly, the lateral support structure is built in the direction of movement of the recoater from the object. Moreover, the lateral support structure may be wider at the bottom than at the top. The wider bottom provides stability for the lateral support structure to resist any forces generated by the recoater.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

1. A method for fabricating an object, comprising:
(a) irradiating a first portion of a layer of powder in a powder bed with an energy beam in a first series of scan lines to form a fused region;
(b) scanning a second portion of the layer of powder in a second series of scan lines using a reduced energy beam power that is insufficient to fuse the powder;
(c) providing a subsequent layer of powder over the powder bed by passing a recoater arm over the powder bed from a first side of the powder bed to a second side of the powder bed; and
(d) repeating steps (a), (b), and (c) until the fused region forms the object in the powder bed, wherein the second series of scan lines is selected based on a thermal dissipation rate of the first portion.

2. The method of claim 1, further comprising determining the thermal dissipation rate of the first portion based on a thermal model of the first portion.

3. The method of claim 2, wherein a time period for scanning the second portion of the layer of powder in a second series of scan lines allows the first portion to reach a desired temperature according to the thermal model.

4. The method of claim 2, wherein the thermal model of the first portion is based on the first portion of the layer of powder in the powder bed and the fused region in one or more preceding layers.

5. The method of claim 1, further comprising measuring a temperature of the first portion using a pyrometer or thermal imaging camera.

6. The method of claim 5, wherein the scanning the second portion of the layer of powder in a second series of scan lines comprises scanning the second portion until the measured temperature of the first portion reaches a desired temperature.

7. The method of claim 1, wherein the second series of scan lines is selected to maintain a substantially constant ratio between a total scanned area in each layer and a total area of the powder bed.

8. The method of claim 1, further comprising irradiating a third portion of the layer of powder with the energy beam in a third series of scan lines after scanning the second portion, wherein the third portion of the layer of powder is separated from the first portion of the layer of powder by a distance less than a width of the energy beam.

9. The method of claim 1, wherein an area of the first portion is less than a threshold value.

10. The method of claim 1, wherein the first portion is based on a horizontal cross-section of a three dimensional model of the object and the second portion is based on a horizontal cross-section of a separate support in the three dimensional model.

11. A method of fabricating an object based on a three dimensional computer model including the object and a solid support adjacent to the object using a manufacturing apparatus including a powder bed, energy beam, and a recoater arm, comprising:
scanning a first set of scan lines corresponding to the object with the energy beam using a first power that is sufficient to melt a layer of powder in the powder bed; and
scanning a second set of scan lines corresponding to the solid support in the powder bed with the energy beam using a second power that is insufficient to fuse the layer of powder in the powder bed.

12. The method of claim 11, wherein the second set of scan lines is selected to maintain a substantially constant ratio between a total scanned area in each layer and a total area of the powder bed.

13. The method of claim 11, further comprising adding the solid support to the three dimensional model, wherein the solid support, in each horizontal layer, has a cross-sectional area such that a total cross-sectional area of the solid support and the object exceeds a threshold value.

14. The method of claim 11, wherein the additive manufacturing apparatus includes a processor executing a control program that controls the additive manufacturing apparatus according to the model.

15. The method of claim 14, further comprising setting, using the control program, the first power for the object and setting the second power for the solid support.

16. The method of claim 15, wherein the second power is zero.
